(19) United States
(12) Patent Application Publication
(10) Pub. No.: US 2020/0284075 A1
(43) Pub. Date: Sep. 10, 2020

(54) TWO PIECE KEY AND RECEIVING HOUSING FOR USE AS A LOCKOUT ASSEMBLY FOR DEACTIVATING A PRESS OR ROBOTIC CEL

(71) Applicant: U.S. Farathane Corporation, Auburn Hills, MI (US)

(72) Inventors: Steve Porter, Auburn Hills, MI (US); John Klinkman, Auburn Hills, MI (US); Kevin Wilson, Rochester Hills, MI (US)

(21) Appl. No.: 16/813,274

(22) Filed: Mar. 9, 2020

Related U.S. Application Data
(60) Provisional application No. 62/814,902, filed on Mar. 7, 2019.

(51) Int. Cl. E05C 17/02; E05B 27/00

(52) U.S. Cl. CPC E05C 17/02; E05B 27/0028

(57) ABSTRACT

A two piece lockout key assembly having a key inserting portion and a mating recess configured within a receiving housing body. The two piece key assembly further provides, in a first variant, a press retractable bearing and seat arrangement configured within a cylindrical shaped receiving body for providing quick single handed bypass/switch engagement by the user irrespective of the rotational position of the insert portion of the key relative to the fixed outer receiving portion. In a second variant, a pair of clasps are pivotally mounted to the body for engaging a lockout cell frame location.

### CROSS REFERENCE TO RELATED APPLICATIONS

The present application claims the priority of U.S. Ser. No. 62/814,902 filed Mar. 7, 2019, which is incorporated herein in its entirety.

### FIELD OF THE INVENTION

The present application discloses a two piece lockout assembly, including in a first variant a simplified cross sectional shaped (such as cylindrical) key insertion portion and mating outer cross sectional shaped lockout frame mounted key receiving housing portion. The two piece assembly further provides, in combination, press retractable bearings, spheres or other circumferential projections in combination with a seat arrangement for providing quick single handed removal of the frame mounted lockout housing body by the user, regardless the rotational orientation of inserted key portion relative to the fixed outer receiving portion.

In a second variant, the two piece assembly again includes a cylindrical or other like shaped key insertion portion. A reconfiguration of the lockout housing includes an inlet aperture for receiving the insertion portion, the housing including an interior configuration with a further cylindrical displaceable portion which, upon being engaged by the insertion portion, actuates a pair of laterally displaceable and arcuate shaped clasp elements pivotally supported to the housing to pivot open for removing the lock/lockout assembly.

Without limitation, the reconfigured housing of the second variant can engage through a door frame proximate located aperture in order to operate as either a lockout style housing in similar fashion to the outer mounted portion of the first variant, such as again to maintain the lockout cell door opened so that the powered equipment/press remains in a non-operating and bypassed condition. Alternatively, the housing can be reconfigured in a fashion similar to a conventional padlock shaped body and so that the clasp elements can engage a door or panel enclosure to maintain the same in a closed or locked configuration within a supporting frame structure and according to additional potential applications.

### BACKGROUND OF THE INVENTION

The prior art is documented with lock-out key assemblies, such as which can be used with an access door of a robotic cell or cage. As is known, normal operation of the press or other power equipment within the cell/enclosure requires that the door be closed relative to the surrounding frame in order close a circuit for providing power to the equipment during normal operation.

During times in which access to the interior of the cell is required, such as by a technician for conducting any of servicing, repair or recalibration of the equipment, industrial regulations require that the door be “locked out” or maintained in an open condition relative to the surrounding frame, such that the circuit is opened and power thereby disconnected to the press or other machinery. As such, the purpose of establishing the lock-out condition is to isolate the door in the open position, thereby deactivating power to the robot or press, and preventing the door from being reclosed until the lock is removed and following departure of the technician from within the cell.

Traditional lockout assemblies typically include a conventional padlock which is attached to an aperture location of a frame or jamb surrounding the cell door and, when engaged, extending within the interior frame opening to prevent the associated door from being closed. Unless a combination style lock is used, a key is typically utilized by the operator/technician in deactivating and locking open the cell/cage door.

Examples of other existing assemblies also include the key switch of Braun, U.S. Pat. No. 4,980,524 which is operable by a cylinder lock. Braun further teaches a cylinder housing is provided, with a cylinder core arranged to be rotatable within the housing. The housing is coupled with a non-conducting switch rotor and a switch casing base, in which the switching arrangement is located and the switch rotor is guided. Other examples of key switch assemblies include that disclosed in Takenaka U.S. Pat. No. 7,345,252 and Kajio U.S. Pat. No. 6,307,167.

### SUMMARY OF THE PRESENT INVENTION

The present invention discloses a two piece key and removable lock assembly, such again including an inserting key portion and a lockout portion for receiving the inserting key portion at any rotational orientation, thereby allowing removal of the lockout portion along with the inserting key portion from the cell frame. In a first variant, the lockout cell mounting portion includes an outer receiving housing having an elongated body adapted to being engaged within an opening in a frame location associated with a door, the outer housing (also termed an outer key portion) further including at least one laterally projecting portion which, upon the outer key portion being installed with the assistance of the inner key engaging portion, prevents axial withdrawal from the frame location (again to maintain the open circuit lockout condition to the press equipment).

The inner key inserting portion exhibits an end face profile which, upon being engaged through a passageway or opening in the outer receiving housing, contacts an opposing mating profile of the intermediate component, such provided in the form of the elongated pins supported within the receiving housing in extending fashion through the intermediate component, with displacement of the pins resulting from contact of the keyed inserting portion in turn acting against displaceable slides causing the laterally projecting portion to become circumferentially retracted into an interior of the outer key portion, subsequently permitting withdrawing removal of the combined inner key and receiving body.

Additional features include the lockout cell mounting portion having a body with an interior configuration for supporting at least one, and typically a pair of the linearly displacing slides for seating the elongated pins, a notched lateral exterior location configured in each of the slides aligning with the projecting portions to facilitate each of install or removal actions. The at least one laterally projecting portion may further include a pair of spheres or other elements, which can further include, without limitation, a spherical ball of like element which (in the engaged lockout condition) projects outwardly of a circumferential outer surface defining the outer housing to prevent the same from being removed from the lockout cell or frame.

The at least one slide can further include a pair of slides responsive to keyed displacement of the elongated pins or portions on opposite side locations of the housing body. The slides are further shown positioned in a side-by-side configuration within the outer key portion. Alternatively, the slides can be positioned in a stacked arrangement within the outer body or key portion, allowing for each slide to engage both of the projecting spheres or other configured projecting elements.

The opposing end profile of the intermediate component supported within the outer receiving body (again also termed an outer key portion or lockout frame mounted portion), may include a coaxial arrangement of projecting rings according to a given axial length and diameter and which, upon being contacted by the opposed mating profile of the inserting key portion, resulting in a keyed displacement of the elongated pins extending through the intermediate component in order to displace the slides to a position in which the spheres align with the outer recesses or notches in the slides and the apertures formed in the sides of the lockout housing for retracting the spherical elements. The axial projecting rings of the inner key portion are therefore keyed to a specific length and diameter pattern which is sized to match a specific opposing pattern defined in the intermediate component of the lockout housing member and in order to determine a degree of axial displacement of the slides and spheres within the outer key (our lockout cell housing mounted) portion.

A pair of annular recessed valleys are configured into a forward facing end of the intermediate component and communicates with additional seating recesses configured within a rearward facing end through which are received elongated pins projecting from the slides. The springs bias the slides in a direction towards the open end of the outer key portion. An interior wall supports the slides at an intermediate location of the outer key portion separating the open end and a closed distal end.

Axial displacement of the axial projecting rings causes the elongated pins to displace forwardly from the fixed intermediate component to contact and displace the slides to retract the spheres within the outer key portion interior. The lateral projecting portions can again further include any of a sphere, rectangular, or other shape bearing or like projection for preventing axial withdrawal in the lockout condition and without the matching key inserting portion being engaged within the lockout frame mounted housing to allow the side projecting spheres/pins to inwardly seat within the circumference of the lockout housing to establish a smooth circumferential surface for either installation or removal of the lockout mounting portion.

In a second variant, the key assembly includes a similarly configured cylindrical key insertion portion, with the key receiving portion (also termed as either of a lock or lockout housing) including a housing body having an inlet aperture for receiving the key insertion portion. The lock/lockout housing include an interior configuration with a further cylindrical or similar shaped intermediate component supported within an interior track profile and which, upon being engaged by the insertion portion, allowing the insertion portion to influence a pair of elongated pins extending through the intermediate component to displace interior located slides for in turn causing a pair of spring loaded clasp elements pivotally mounted to the lockout housing to pivot in an outwardly laterally spaced and open forward end position.

The pair of slides are again configured in communication with the inner displaceable elongated pins and, in response to notches configured in the slides being displaced into alignment with opposing arrayed inward projections configured at inner ends of the clasp elements, providing quick single handed bypass/switch engagement by the user, again irrespective of the rotational orientation of position of the insert portion of the key relative to the outer receiving portion;

Secondary springs can be embedded in the lock/lockout mounting housing for biasing the slides in a direction relative to the clasps to maintain their forward projecting ends in an opposing abutting and locked position. The slides also include underside tabs which are biased by the embedded secondary springs toward the key inserting end of the lock housing to maintain the outer configured recess notches of the slides out of alignment with the inward clasps engaging end portions and to thereby prevent inadvertent opening (defined again as outward pivoting and lateral displacement) of the clasp elements at their opposing and contacting forward ends of the clasps which are located on an opposite side of the pivot mount to the inward end projections. Upon inserting engagement of the inner cylindrical portion with the mating receiving portion, the notches in the displaceable slides are aligned with the inward pin projections of the clasp elements, at which point an additional biasing spring extending in a lateral or width extending direction within a forward interior of the lockout housing between the clasps influences the same to pivot their forward ends outwardly to the open position.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of a two piece key assembly according to one variant of the present invention having an cylindrical insertion portion and outer cylindrical recessed and receiving portion;

FIG. 2 is a partial axial cutaway view of the two piece key assembly of FIG. 1 and further depicting, in combination, a press retractable bearing and seat arrangement for providing quick single handed bypass/switch engagement by the user irrespective of the rotational position of the insert portion of the key relative to the fixed outer receiving portion.

FIG. 3 is a rotated axial cutaway and exploded view based on the illustration of FIG. 2 and further showing a unique and variable combination of coaxial pin seating locations associated with the projecting sleeves/rings associated with the inner key inserting portion, these positioned relative to a fixed intermediate component which is in turn integrated into the outer key (pin) portion and which seats the pins projecting from the slides for engagement by the coaxially aligned and linearly offset rings of the inner key inserting portion in order to establish the desired keyed engagement between the first and second key portions;

FIG. 4 is a further rotated view of FIG. 3 and depicting the pair of pins and interconnected and spring-bias supported slides incorporated into the outer cylindrical receiving portion and which, upon insertion of the keyed rings or sleeves of the first keyed portion within the coaxial recesses of the fixed intermediate component, act upon the pins, in turn causing keyed linear displacement of the slides which, upon matching the correct inner key portion, facilitates displacement of side projecting balls, spheres or other configured seating portions in an inward recessing direction (laterally) relative to side pockets configured into the slides, again upon the pockets aligning with lateral apertures configured into the housing of the outer cylindrical portion;

FIG. 4A is an enlarged partial perspective of the first key inserting portion with unique combination of dual ring diameter of varied lengths for seating with the opposing coaxial recesses of the fixed intermediate component;

FIG. 4B is a rotated illustration of FIG. 4A and further showing the key ring diameters integrated into the intermediate component which exhibit matching valleys for receiving the coaxially spaced and varied linear projecting sleeve portions of the dual ring diameter portions of the first key inserting portion;

FIG. 4C is a further rotated illustration of the fixed intermediate component and further showing the pin receiving locations configured within the intermediate component for seating the pins projecting from the linearly displaceably supported slides;

FIG. 4D is an enlarged axial cutaway illustration depicting the keyed engagement of the varied axial projecting sleeve portions (or rings) of the first key inserting portion with the pins, the unique axial length of each first key inserting sleeve/ring in turn causing varying displacement of the slides to align their outer lateral recesses to permit retraction of the balls/spheres integrated into the outer receiving portion;

FIG. 5 is a further rotated linear cutaway of FIG. 2, similar to that shown in FIG. 4D, and better illustrating the inner key portion fully inserted, thus causing the offset rings/sleeves in engagement with the pins extending through the intermediate fixed component, and in turn pressing/displacing the slides into correct position for retracting the engagement spheres and accomplishing removal of the outer cylindrical (pin) portion, via inward seating displacement of the spheres within the pockets;

FIG. 6 is an environmental illustration of the two piece key in an initial install configuration associated with a frame location of a lockout cell door;

FIG. 7 is a crosswise cutaway view taken along line 7-7 of FIG. 6 and depicting the removal of the inner (inserting) key portion, with the outer (pin) portion retained within the open interior of the door frame and prevented from being axially retracted by the laterally projecting spheres abutting against inside edges of the door frame which define the insert aperture through which the outer key (pin) portion is installed;

FIG. 8 is an assembled perspective of the lockout key assembly similar to FIG. 1;

FIG. 9 is a cutaway perspective similar to FIG. 3, with the biasing coil springs removed;

FIG. 10 is a further linear cutaway of the key lockout assembly and further depicting the matching coaxial profile of the intermediate fixed component opposing that of a given coaxial sleeve or ring array of the first key inserting portion and, when viewed in combination with FIG. 4, further depicting the ability of the pins to seat in extending fashion though the receiving locations in the intermediate component so that the first key inserting portion, regardless of angular position, enables coaxial contact of the rings/sleeves against the pins for displacing the same according to the keyed profiles and for accomplishing each of key install or retraction relative to the cell/cage lockout door frame;

FIG. 11 is an illustration of an variant of the present invention, with the cylindrical configuration of the outer housing removed, and in which the slides are reconfigured in a stacked arrangement one atop the other, and as opposed to being positioned side-by-side, such allowing for each slide to engage both side positioned balls and requiring both slides to be in position before either ball will move to the unlocking/retracting position;

FIG. 12 is rotated side view of the configuration of FIG. 11 and showing from another angle the alignment of the notches in the sides of the stacked plates for seating and retracting the balls to permit each of engagement and retraction;

FIG. 13 is a partial perspective cutaway of the stacked slide configuration of FIGS. 11-12 and better illustrating the configuration of a coil biasing spring associated with each of the plates, located both above and below the stacked plates, and biased against the angled abutment portions 120 and 122;

FIG. 14 is a perspective illustration of a two piece key assembly according to a further variant of the present invention having a cylindrical insertion portion and a lock housing having an inlet aperture for receiving the insertion portion, the housing including an interior configuration with a further cylindrical displaceable portion which, upon being engaged by the insertion portion, actuate a pair of laterally displaceable and arcuate shaped clasp elements;

FIG. 15 is a partial axial cutaway view of the two piece key assembly of FIG. 14 and further depicting the spring loaded clasp elements pivoted to an outwardly laterally spaced and open position in response to notches configured in the slides aligning with opposing inward pin projections associated with the clasp elements for providing quick single handed bypass/switch engagement by the user irrespective of the rotational position of the insert portion of the key relative to the fixed outer receiving portion;

FIGS. 16 and 17 provide first and second rotated views of the assembly in FIG. 15 and depicting the concentric arrayed rings associated with each of the opposing cylindrical portions of the inserting key and the mating receiving portion displaceably mounted within the lock housing;

FIG. 18 provides a further rotated and downward looking perspective illustration depicting the interior of the lock housing with the slides removed in order to illustrate embedded springs for biasing the slides in a direction relative to the clasps to maintain them in the locked position;

FIG. 19 is a further cutaway perspective showing the tabs associated with the slides which are biased by the embedded springs in FIG. 18 toward the inserting end of the lock housing to prevent opening lateral displacement of the clasp elements; and

FIG. 20 is a succeeding illustration to FIG. 18 depicting an inserting engagement of the inner cylindrical portion with a mating receiving portion so that the inward pin projections of the clasp elements align with and seat within the outward notches of the displaceable slides in order to permit the width extending biasing spring to pivot the clasp elements to the open position.

### DETAILED DESCRIPTION OF THE PREFERRED EMBODIMENTS

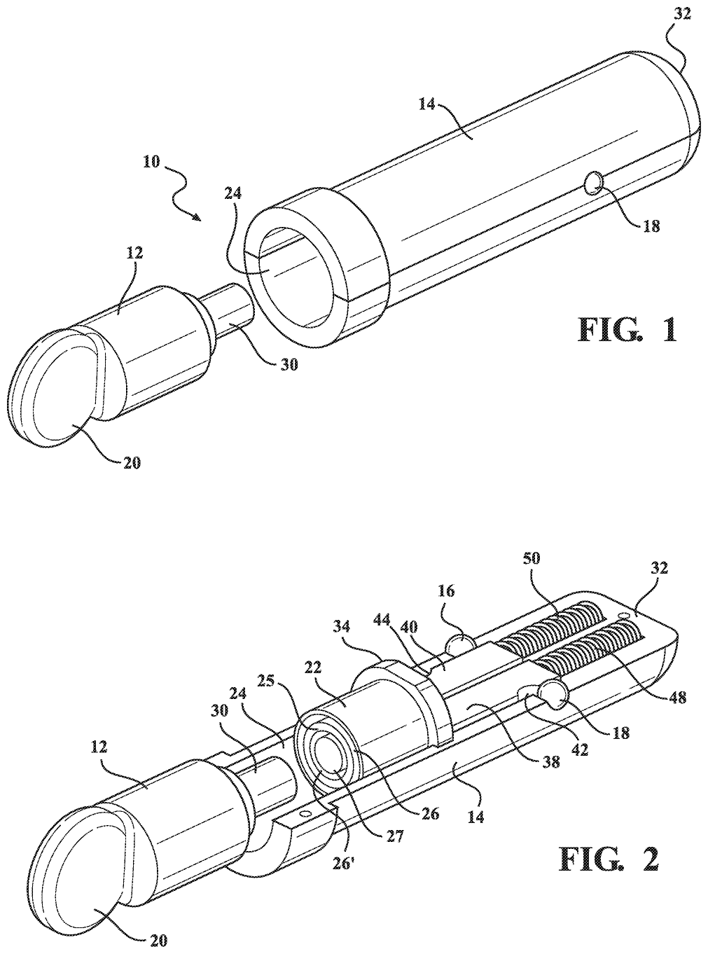

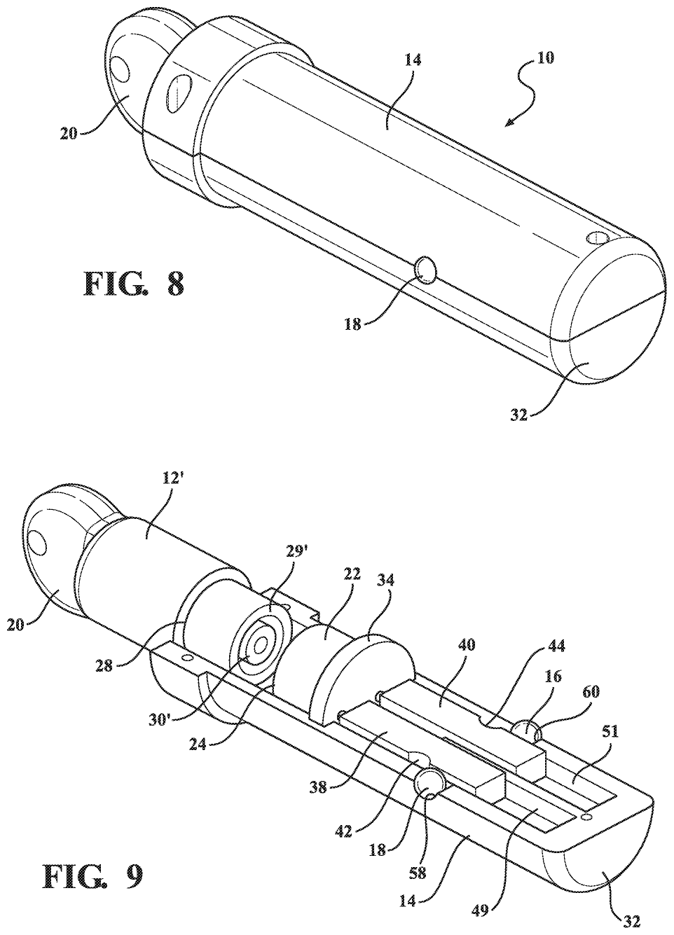

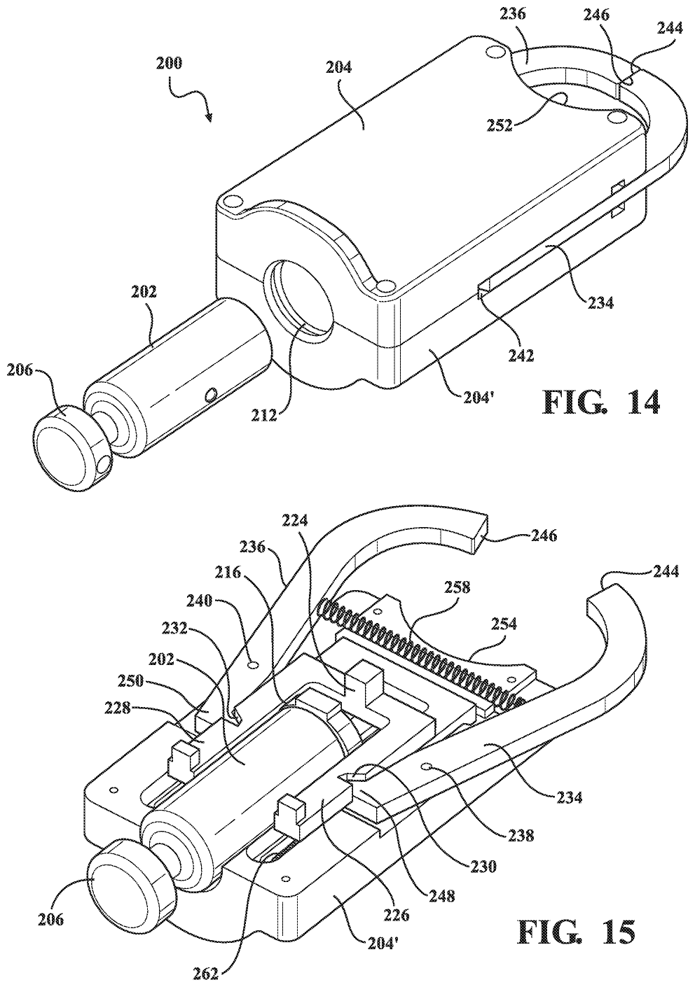

Referring to FIGS. 1-10, the present invention discloses a two piece lockout key assembly, depicted generally at 10 in each of FIGS. 1 and 8. A sub-variant of a two piece lockout key assembly is further disclosed with reference to FIGS. 11-13, at 100. A further embodiment of a two piece assembly is separately depicted at 200 with reference to succeeding FIGS. 14-20.

As will be further described, the lockout key assembly in any variant disclosed provides a simplified arrangement for keying in a paired fashion both of a specific and simplified first key insertion portion 12 and a second outer key receiving portion 14, such further being defined interchangeably as a lockout mounted body or outer body portion for receiving the key inserting portion 12. The two piece key assembly further provides, in combination, a press retractable bearing/sphere/ball or other pin and seat arrangement for providing quick single handed bypass/switch engagement by the user irrespective of the rotational position of the insert key portion 12 relative to the fixed outer receiving body or outer key portion 14 to provide either of paired engagement or removal of the two piece assembly from the robotic cell lockout enclosure.

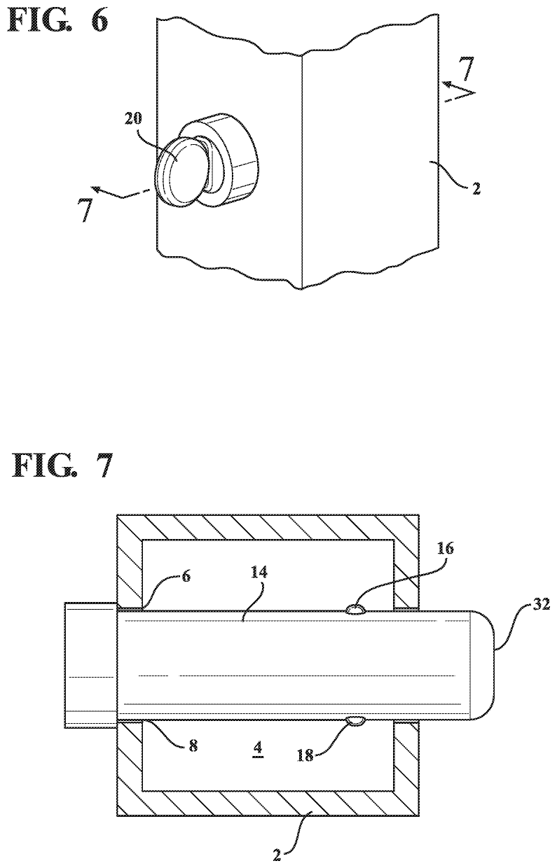

Prior to a detailed description of the lockout key assembly, reference to FIG. 6 depicts an environmental illustration of the two piece key in an initial install configuration associated with a frame location 2 of a lockout cell door, such as can be utilized in a powered cell arrangement for securing any of a robotic, press, arm or other process in which unanticipated contact with an operator, technician or other individual can result in injury or death. As previously described, it is desirable to provide a quick, effective and inexpensive assembly for ensuring the cell door remains in an open position (and thus power to the press or robot is short circuited to the open position) during any scheduled maintenance or downtime of the robot or press.

Referring to FIG. 7, an open interior (at 4) of the door frame 2 is shown and by which the previously installed outer key (pin) cylindrical body 14 is prevented from being axially retracted, this owing to the laterally projecting portions 16 (also termed balls, bearings or spheres) which are normally outwardly circumferentially projecting from the exterior circumferential surface of the inserted lockout portion 14. While both the inner key inserting portion 12 and outer lockout cell mounted body 14 are shown having a cylindrical cross sectional shape, it envisioned and understood that the mating interface established between outer circumferential surface of the inserting key portion and the opposing receiving passageway configured within the outer lockout mounting body or portion 14 can also be reconfigured in other polygonal cross sectional shapes not limited to such as rectangular, hexagonal, octagonal or the like.

The outwardly displaced spheres 16/18 abut against inside edges (see further as depicted at 6 and 8) of the door frame 2 which define therebetween the insert aperture through which the outer lockout body portion 14 is installed. For purposes of the present description, the illustration of the laterally projecting portions are depicted as the spheres or balls, again at 16 and 18 as provided herein, with it further understood to most broadly represent any type of laterally displaceable pin which can further extend beyond a spherical shape to include any of a square, rectangular, other polygonal, arcuate, ellipsoidal or other shape seating portions.

Referring again to FIG. 1, a perspective illustration is again shown of a two piece key assembly according to the initial variant 10 of the present invention having the cylindrical insertion portion 12 and outer cylindrical recessed and receiving body portion 14, such being depicted in partially linear exploded fashion. The key assembly is constructed of any material not limited to metal, heavy duty plastic (e.g. nylon) or other material exhibiting the necessary properties.

As further shown, the inner and inserting key portion 12 also includes a flattened disk shaped gripping end portion 20 (this can also be substituted by other shapes or profiles). FIG. 2 provides a partial cutaway view of the two piece key assembly of FIG. 1 and further depicts, in combination, the press retractable bearings (also again shown in non-limiting example by balls or spheres 16 and 18) along with the seat arrangement for providing quick single handed bypass/switch engagement by the user, and without regard to the rotational position of the insert portion 12 of the key relative to the fixed outer receiving body portion 14. As described above, and without limitation, the balls/spheres 16/18 can also be depicted in any other shape not limited to elliptical, oblong, arcuate, square or other polygonal shapes, such consistent with the recess profiles in the side walls of the receiving housing and the recessed configured in the edges of the associated displaceable slides.

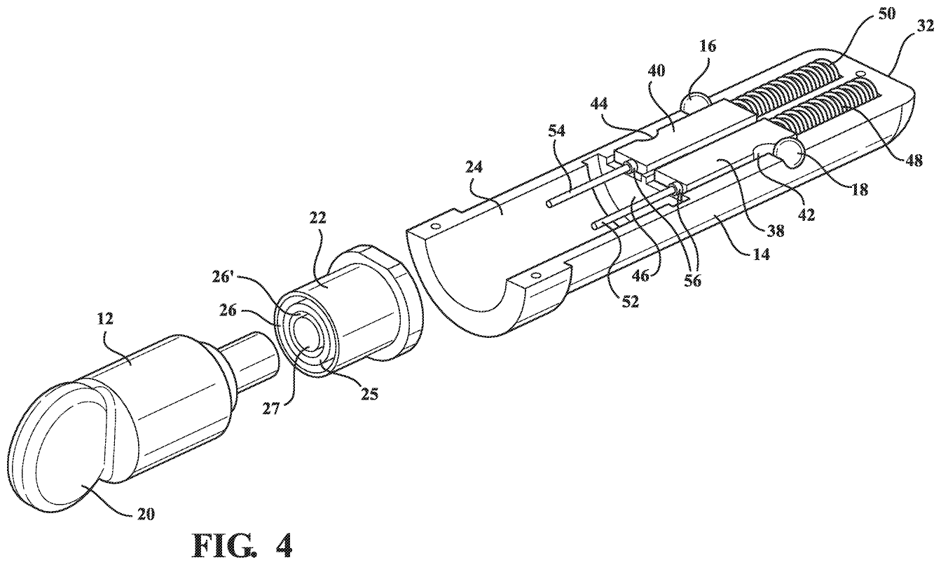

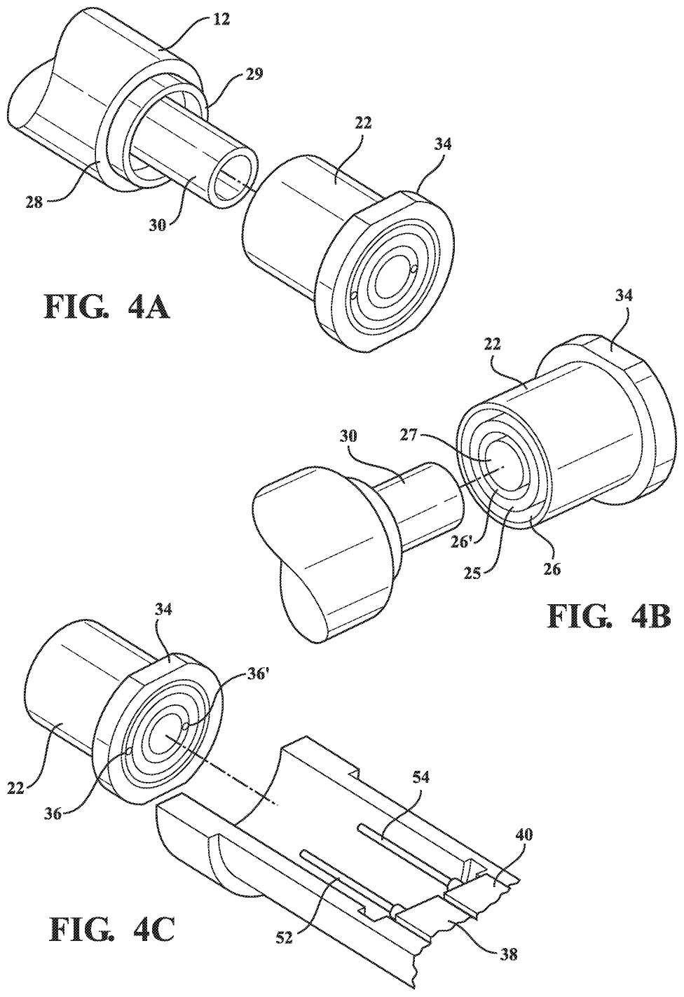

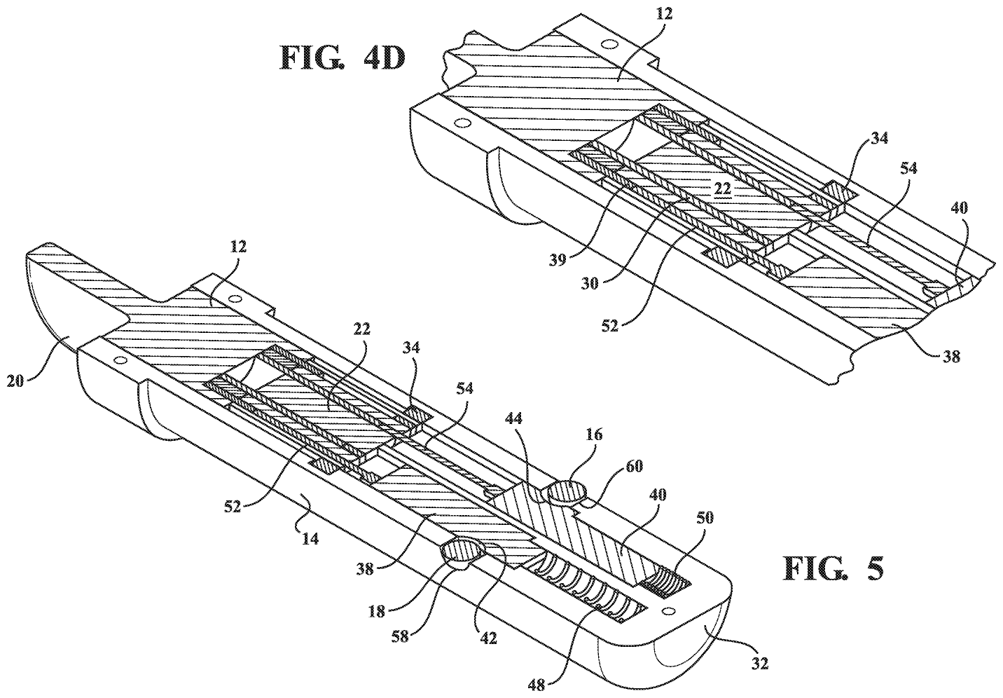

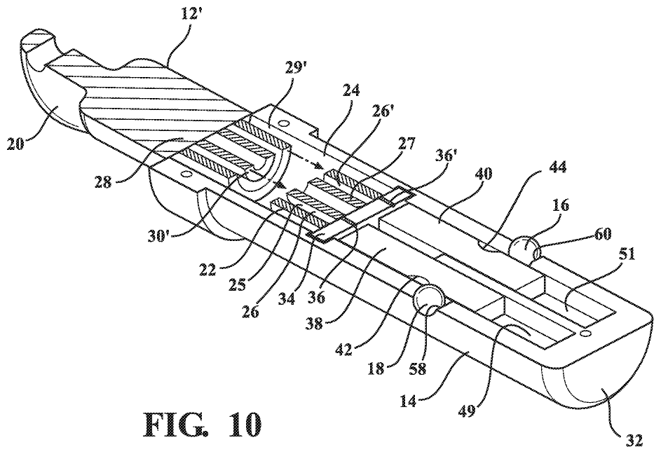

A fixed intermediate component is depicted at 22 which is supported within an inner cylindrical surface location (see surface 24) of the outer cylindrical (pin) body 14 (see FIG. 10) which defines a receiving passageway within which is inserted the inner key portion 12. The fixed intermediate component 22 includes, as best again shown in FIG. 10, a pair or coaxial annular recesses, or valleys, shown at 26 and 26′ arranged between alternating outer 25 and inner 27 coaxially spaced solid portions (see also FIGS. 4B and 4D) of the intermediate component.

The inserting end portion of the inner key 12 depicts an outermost diameter end surface 28 (see FIG. 4A), from which axially projects coaxial outer 29 and inner 30 linearly spaced extending rings or sleeves (also annular walls), these in turn defining the desired engagement with the slides and pins associated with the second key portion 14 as will be further described. The dimensioning of the coaxial rings (again also sleeves or walls) 29/30 mates with the coaxial annular recesses 26 and 26′ configured between the coaxial solid portions 25/27 of the fixed intermediate component 22 and such that, upon inserting the keyed rings or sleeves 29 and 30 of the keyed portion 12 into the outer body 14, the pins associated with the slides being seated within the fixed intermediate component 22 are caused to displace in a forward direction along with their associated slides and towards a distal end 32 of the outer pin portion 14.

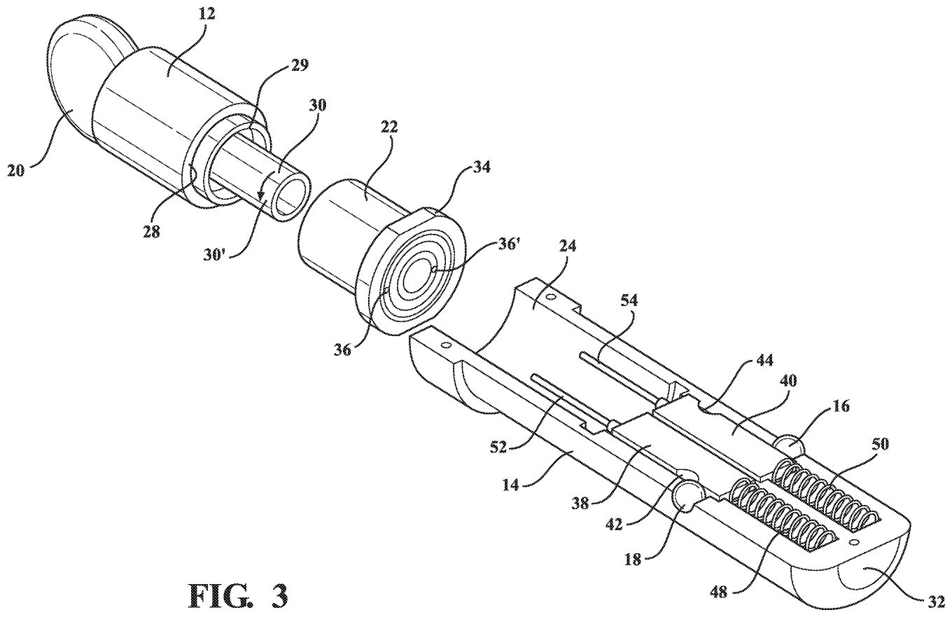

FIG. 3 is a rotated and exploded view of FIG. 2 and further showing a unique and variable combination of coaxial seating diameters, see again outermost annular end face 28 of the inner key portion 12, from which projecting outer annular coaxial portion 29 and a modified inner-most coaxial diameter portion 30, this modified from that shown in FIG. 10, so that the inserting key portion 12 can be keyed to a specific configuration of annular recess pattern configured within the coaxial opposing arrangement of the intermediate component 22. As shown, the fixed intermediate component 22 includes an end cap portion 34, this defining an end face within which is configured a pair of pin receiving locations, shown at 36 and 36′.

As further shown in FIG. 3, supported within the cylindrical interior recess of the outer two piece key portion 14, forward of the intermediate component 22, are a pair of linearly displaceable slides 38 and 40. As shown in FIG. 4, the slides 38 and 40 each include an elongated, rectangular three dimensional shape, with each exhibiting an outer lateral notch (see at 42 for slide 38 and further at 44 for slide 40). As will be further described, the laterally outwardly configured notches 42/44 in the slides are aligned with recess locations of the outer body housing 14, within which reside the balls or spheres 16/18 and, upon which are caused to seat inwardly from the position shown in FIG. 7, by which the outer cylindrical key body or outer portion 14 is then permitted to be removed from the lockout cell.

As best shown in FIG. 4, the slides 38/40 are supported in a limited linear displaceable fashion within a forward end of the outer body 14 and seated through the receiving locations 36/36′ in the intermediate component 22 so that the pins (shown at 52 and 54) project within the communicating coaxial recesses or valleys 26/26′ in the intermediate component. As further shown, a midpoint located interior wall 46 in the outer body 14 defines a rearward most displaced position of the slides 38/40 as influenced by a pair of coil springs 48 and 50 which in turn seat within forward-most cylindrical pockets (see at 49 and 51 in FIG. 9) within the outer body 14, these in communication with the forward distal end 32. The pair of elongated pins 52 and 54 accordingly extend from inner facing ends of the slides 38 and 40, with the pins 52/54 projecting through cutout locations 56 of the interior wall 46 (see again FIG. 4) before extending into the fixed intermediate component 22 via the receiving locations 36/36′ and communicating valleys 26/26′ in the manner described.

With reference to FIG. 4A, it provides an enlarged partial perspective of the first key inserting portion, again at 12, with the unique combination of dual ring diameter sleeves of varied lengths 29 and 30, again for seating within the opposing coaxial recesses or valleys (26 and 26′) defined of the fixed intermediate component 22. FIG. 4B is a rotated illustration of FIG. 4A and further shows the key ring diameters 25/27 integrated into the intermediate component which exhibit matching valleys 26/26′ for receiving the coaxially spaced and varied linear projecting sleeve portions 29 and 30 of the dual ring diameter portions of the first key inserting portion 12.

Proceeding to FIG. 4C, a further rotated illustration is shown of the fixed intermediate component 22, and further showing the pin receiving locations configured within the intermediate component for seating the pins 52/54 projecting from the linearly displaceably supported slides (38 and 40). This is better illustrated with succeeding reference to FIG. 4D which provides an enlarged axial cutaway illustration depicting the keyed engagement of the varied axial projecting sleeve portions (or rings) 29 and 30 of the first key inserting portion 12 with the pins 52 and 54, these further shown so that each pin seats through this receiving recess 36/36′ and rests within a selected one of the annular recesses or valleys 26 or 26′ configured within the fixed intermediate component.

As shown, the unique axial length of each first key inserting sleeve/ring 29 and 30, upon linear insertion of the first key portion 12 in any rotated position, causes the rings 29/30 to slide within the overlapping valleys 26/26′ into abutting contact with the pins 52/54 pre seated within the receiving locations 36/36′ of the intermediate component 22. Insertion of the inner key portion 12 to the extent permissible in turn causes the varying displacement of the pins 52/54 and associated slides 38/40 and which, assuming the correctly matched inner key portion 12 is inserted into the outer key or body portion 14 regardless of rotational orientations, results in correct axial aligning of the slides 38/40 with their outer lateral recesses (see at 58/60 in FIG. 5) to permit retraction of the balls/spheres 16/18 integrated into the outer receiving portion;

As further supported by the cutaway view of FIG. 5, the pins 52/54 extend through the recess locations 36 and 36′ in the intermediate component 22, again in communicating fashion within the interior valleys or recesses 26/26′ of the intermediate component 22. In this fashion, and upon the coaxial keyed relationship established between the unique combination of the ring diameters 29/30 (see again FIGS. 3 and 4D) of the inner key inserting portion 12 seating with the opposing coaxial diameter pattern defined by the recesses 26/26′ configured between the coaxial solid portions 25/27 of the intermediate component 22, the inner key portion 12 is pressed inwardly, again regardless of rotational position relative to the outer cylindrical (inserting key receiving) body portion 14, in order to displace pins 52/54 in a direction outwardly of their seating recesses 36/36′ in the fixed intermediate component 22, the pins and slides being individually displaced according to the keyed linear dimensioning of the rings 29/30 in the inner key portion 12.

As further shown, the pins 52/54 are biased forwardly along with their connected slides 38/40 in counter biasing fashion against the forward end biasing coil springs 48/50. Upon being engaged by the extending keyed rings 29/30 of the inner key portion 12 (again through the fixed intermediate component 22) the pins 52/54 and interconnected slides 38/40 are thus forwardly displaced to their aligning positions in which the balls 16/18 and permitted to retract within the receiving notches/pockets 42/44 in the lateral outer edges of the slides 38/40 and so as to be fully recessed into the slide pockets 42/44 to permit withdrawal of the outer body 14 from the installed lockout position depicted in FIG. 7 along with the insert inner key portion.

As previously noted, a number of factors are taken into account in the designing of the inner 12 key portion and outer 14 body receiving portion to allow for pairing of the key portions so that a selected inner key 12 will only engage, displace and successfully align the pins and slides for removal of the outer portion 14. This can include any offset arrangement in the configuration of the slides 38/40 (see again FIG. 5) as well as the location of the seating notches 42/44 in the slides relative to the side exposed recess locations in the outer key portion 14 for permitting retraction of the spheres 16/18 and resultant linear withdrawal of the outer pin 14 from a jamb frame engaged position as shown in FIG. 7.

With reference again to FIG. 4, this provides a further rotated view of FIG. 3 and depicts a pair of elongated pins 52/54 extending through the intermediate component 22 to interconnect the spring-bias supported slides 38/40 incorporated into the forward region of the outer cylindrical receiving portion 14. Upon displacement of the pins 52/54 through the fixed intermediate component 22, again resulting from insertion of the inner keyed rings 29/30 associated with the first key portion 12 acting upon the opposing keyed array 25/27 of the intermediate component 22, pins and slides, facilitating displacement of slides 38/40 and associated notches 42/44 into alignment of the notches with the side projecting spheres 16/18, whereupon the spheres are retracted into the side pockets or notches 42/44 configured into the slides.

FIG. 5 is again a further rotated linear cutaway of FIG. 2 and better illustrating the inner key portion 12 fully inserted, thus pressing the slides 38/40 into correct position for re-seating the balls 16/18 into slide configured notches 42/44, thereby accomplishing removal of the outer cylindrical (pin) portion from an install position such as previously shown in FIG. 7 and via the inward seating displacement of the balls or spheres within their mating pockets.

FIG. 8 is an assembled perspective of the lockout key assembly similar to FIG. 1, with FIG. 9 further provides a cutaway perspective similar to FIG. 3 a similar designed two part key assembly, with the biasing coil springs removed and in which a modification of the keyed rings 29′ and 30′ is shown. FIG. 10 is a further linear cutaway of the key lockout assembly and further depicting the matching coaxial profile of the intermediate fixed component 22, this again opposing that of the keyed rings 29′/30′ of the redesigned inserting portion 12′ (see also FIG. 9) and which, when viewed in combination with FIG. 4, further depicts the ability of the elongated pins 52/54 (not depicted in this figure but again shown in FIGS. 4C and 4D) to seat within the seating channels 36/36′ of the intermediate component 22 in communication with the interior valleys 26/26′ defined in the intermediate component. FIG. 10 again shows passageways 36 and 36′ which extend through the enlarged end 34 of the intermediate component 22, these in communication with the interior valleys 26 and 26′ for receiving the elongated pins 52 and 54 and so that inward displacement of the component 22 results in through displacement of the pins 52/54 resulting in keyed displacement of the slides 38 and 40 and their side notches 42/44.

As previously noted, engagement between the key portions 12/14 again occurs regardless of the relative rotational position of the insert key portion 12 relative to the outer cylindrical lockout installed portion 14 for accomplishing each of key install or retraction relative to the cell/cage lockout door frame. In this manner, the two piece key provides for ease of single handed install or removal of the outer portion 14 to and from a door jamb location (can also envision a separate bracket with a hole as being the mounting environment apart from an aperture through a door frame location).

Also, and by again keying the dimensions of the slides 38/40 and their recess notches 42/44, such as in combination with varying the lengths of the extending pins 52/54, the ability to pair a specific inner key portion 12 to an outer (door jamb installed) key portion 14 provides a security feature preventing a non-authorized user (anyone not possessing the correct matching inner key portion 12) from removing the outer lockout portion 14 from the door jamb.

Proceeding to FIG. 11, an illustration is generally shown at 100 of a variant FIG. 1 of the present invention, with the cylindrical configuration previously shown at 14 in FIG. 1 of the outer housing removed, and in which the slides are reconfigured as a pair of upper 102 and lower 104 slides in a stacked arrangement one atop the other, and as opposed to being positioned side-by-side as shown in the preceding views. Each of the slides 102/104 is depicted as a generally rectangular thin plate of larger dimension in comparison to the slides 38/40 in the preceding variant, each having a pair of opposite side configured arcuate recesses including a pair 106 and 108 shown for upper slide 102 and a further pair (only one of which is visible at 110) for lower plate 104.

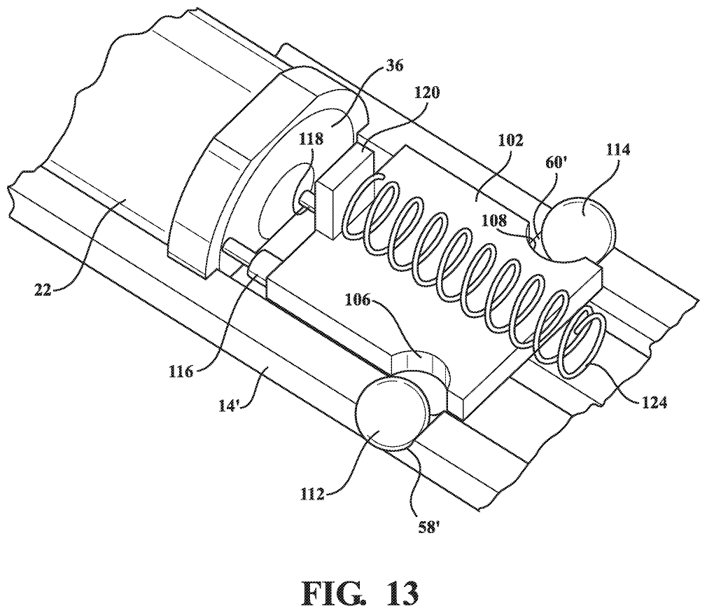

The arrangement of the opposite edge recesses in the slides 102/104 are configured to allow for each slide to engage both balls, further depicted at 112 and 114, thereby requiring both of the slides to be in position before either ball will retract into the aligned arcuate recesses and further permitting each of installation and retraction relative to the outer jamb 2 as depicted in the environmental position of FIG. 7. Although not shown, the outer cylindrical housing (see again at 14 in FIG. 1 and as shown in cutaway in FIG. 2, as well as at 14′ in FIG. 13) includes similar lateral apertures corresponding to those shown at 58 and 60 in FIG. 5 and further depicted at 58′ and 60′ in FIG. 13. The intermediate component is again shown at 22 with enlarged end cap 34 and annular recess pattern 36 configured in its exposed end face.

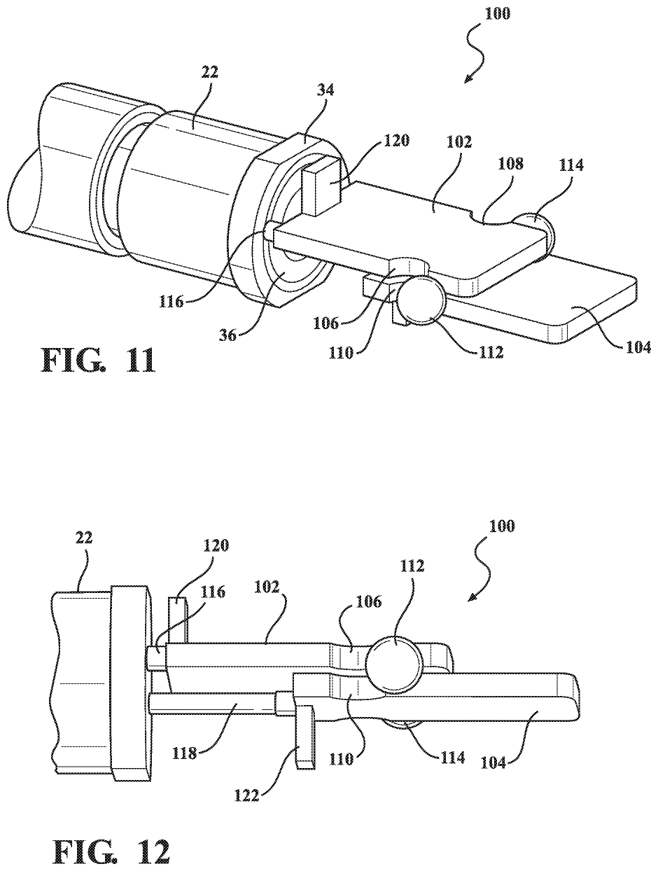

Each of the stacked slides 102 and 104 are supported by elongated pins, these shown at 116 and 118 in each of FIGS. 11 and 12, and which can be provided singularly or in pairs for seating against the recessed end face pattern 36 of the intermediate e component 22. Each of the slides 102 and 104 further exhibits an angled end stop portion, at 120 and 122 respectively, which seats within suitable top and bottom channels or grooves (not shown) configured within the longitudinally extending inner surfaces of the outer cylindrical housing (see again at 14 in FIG. 1), the abutment or stop portions 120/122 providing a seating support to the biasing coil springs (see FIG. 13) and which can be further configured to prevent the slides 102 and 104 from pivoting or rotating in misaligning fashion during displacement within the outer elongated housing. FIG. 12 further provides a rotated side view of the configuration of FIG. 11, and showing from another angle the alignment of the notches in the sides of the stacked plates for seating and retracting the balls to permit each of engagement and retraction.

Referring again to FIG. 13, a partial perspective cutaway is shown of the stacked slide configuration of FIGS. 11-12 and better illustrating the configuration of a coil biasing spring (see selected upper coil spring 124 associated with upper stacked slide plate 102 depicted only with the understanding that a similar lower coil spring is positioned below the lower slide plate 104). In application, at least one coil spring is associated with each of the upper 102 and lower 104 plates, such that each of the springs are located both above and below the stacked plates. As shown, the coil springs are biased against the angled abutment portions 120 and 122 at first ends and, at opposite ends, abut end surfaces associated with interior pockets defined in the outer cylindrical portion (shown at 14′) similar to that shown in FIGS. 3-5 of the initial embodiment 10.

The construction of the variant of FIGS. 11-13 allows for each slide to engage both side positioned balls and further requiring both slides to be in position before either ball 112/114 will retract within the notches defined in the upper and lower plates to unlock the mounted lockout portion and to permit the same to be removed from the frame lockout recess location (see again FIGS. 6-7). The stacked arrangement of the slides provides the advantage of making it more difficult to unlawfully unlock or pick, as opposed to the side-by-side slide variant of FIG. 1. To wit, application of pressure on a single side positioned ball in the first variant could potentially result in the corresponding pin being displaced through the use of a small diameter tool in theory inserted through an exposed end location of the outer housing, and such as until the ball is caused to recess (drop or fall) into the associated side configured recess or pocket within the slide. Continued pressure upon the ball is then maintained while also applying pressure to the second ball, with the second corresponding pin being moved until the second ball falls into the pocket, with both balls then in the retracted/seated position and the lock capable of being removed.

According to the variant of FIGS. 11-12, the ability of both slides 102/104 to engage the balls 112/114 would require an individual trying to pick the lock having to move both pins 116/118 simultaneously to their correct (unknown) positions, and before either ball will inwardly seat or retract (a near impossibility). It is also envisioned that additional variants can include variations of the slide arrangement (either side-by-side as in FIG. 1 or stacked as in FIG. 11) which can accommodate any arrangement of three, four or other plurality of seating balls. Additional variants can incorporating an arrangement of linkages in substitution for the slide configurations.

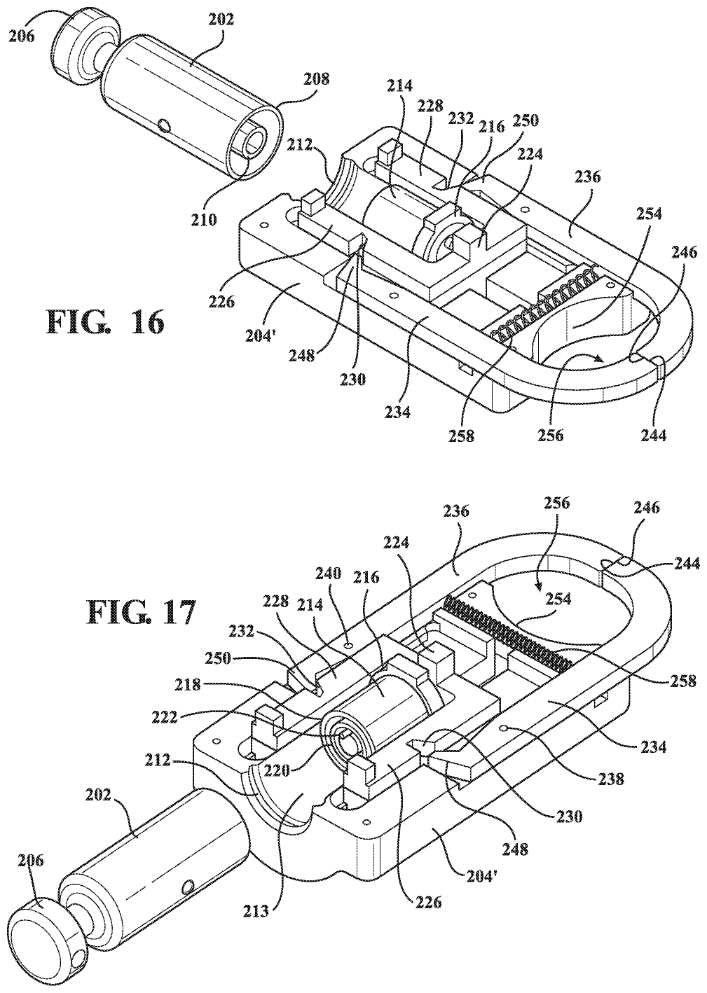

Proceeding to FIG. 14, a perspective illustration is shown at 200 of a two piece key assembly according to a further variant of the present invention and again having a cylindrical insertion portion 202 and a lock or lockout housing, this further including a body having an upper assemble-able half (at 204 in FIG. 14) and a lower sandwiching half 204′, which is further depicted in FIGS. 15-20 to further illustrate the various displacing and clasp engaging features integrated into a housing interior of the body. As best shown in FIG. 16, the inserting key portion 202 is similarly configured to that shown at 12 in FIG. 1 and includes a cylindrical shaped body with a gripping end 206 along with a concentric ring or shoulder array (see outer sleeve shaped shoulder 208 and inner spaced shoulder 210.

The body (shown again as housings 204/204′) includes an inlet (see annular profile 212) for receiving the inserting portion 202. An intermediate component is supported within an annular extending interior 213 of the lockout housing 204 in communication with the inlet rim passageway 212. The intermediate component (similar to that depicted at 22 in FIG. 2) includes a main annular body 214 with an enlarged inner end 216. As best shown in FIG. 17, an arrangement of concentric annular rings or shoulders (see outer 218 and concentric inner spaced at 220) are configured in the opposing end of the intermediate component so that, and upon insertion of the keyed portion 202, the pairs of concentric rings 208/210 of the inserting portion nest with the opposing arrayed and concentric shoulders 218/220 of the intermediate so that elongated pins (see at 222) extending through the intermediate component are displaced by inward motion of the keyed insert portion 202 inwardly through the intermediate component.

A further ‘U” shaped component is provided within the interior of the body (see as supported upon lower housing 204’ in FIG. 15 et seq.). An interconnecting base 224 of the “U” shaped component includes any lower projection which seats within an axial slot recess 225 (se FIG. 19 in which “U” shaped component is removed) and so that the interconnecting base abuts the enlarged inner end 216 of the intermediate portion in contact with the elongated pins 222 extending through the intermediate component. Upon being contacted by the inserted key portion 202, the elongated pins 222 are caused in response to displace through the intermediate component to influence the “U” shaped component, which in turn further includes first and second extending sides of the “U” shaped component which is provided in the form of slide components 226 and 228.

The slides 226/228 each include a notched configuration, see at 230 and 232 respectively, configured on outward facing sides thereof. As further shown the notch configurations each include a series of angled interconnected edges which define a narrowed or pointed inner end which generally corresponds in function to the seating recesses 42/44 of the slides 38/40 shown in the preceding embodiment of FIG. 2. By this construction, inward sliding of the elongated pins 222 through the intermediate component in response to keyed engagement of the key insert portion via nesting of the opposing cylindrical ring arrays, results in the elongated pins 222 (as shown in FIG. 17) displacing through inner end 216 of the displaceable portion for displacing the “U” shaped portion and its extending side disposed slides 226/228 with outward notches 230/232 inwardly within the main body.

FIG. 15 is a partial axial cutaway view of the two piece key assembly of FIG. 14 and further depicting a pair of spring loaded clasp elements 234 and 236 (also termed clasps) which are pivotally supported to side locations of the main body. The clasps 234/236 seat within open side channels (see as shown at 242) defined between the upper and lower housing halves 204/204′.

The clasps 234/236 each include inwardly curved forward ends 244/246 which are in a closed abutting relationship (FIGS. 14, 16, 17 and 19) in a normal and non-actuated condition and corresponding with inward pointing projections 248/250 at inner ends of the clasps seating within the inner angled slide notches 230/232. The assembled housings 204/204′ of the main body further include a concave forward end profile (see at 252 and 254) which define an interior space 256 (see FIGS. 16 and 17) between the housing and the curved forwards ends of the clasps in the closed position for permitting the same to operate either as a conventional lock body or, consistent with the prior variants of FIGS. 1 and 11 to install the curved clasp ends into opposite openings defined in the sides of the frame location 2 of the cell enclosure (see FIGS. 6-7) and so that the clasps can affix the body (204/204′) to the lockout cell in a manner in which it projects within the cell frame to prevent the associated door (not shown) from closing.

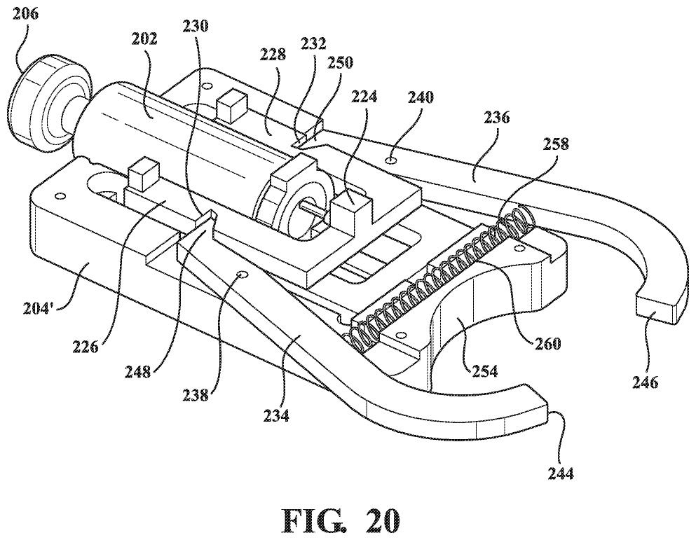

A compressed spring 258 is seated within a lateral or crosswise directed pocket defined within the forward end of the opposing housing halves 204/204′ (selected half pocket 260 shown for lower housing 204′ in FIG. 20). The spring 258 extends between the clasps 234/236 to influence them in a separating direction forwardly of the pivot locations 238/240 and in order to biasing the inward projections 248/250 against the exterior surfaces of the slides 234/236 such that, upon inward displacing alignment of the slide notches 230/232 with the projections, the compressed spring 258 outwardly and laterally displaces the clasps at their forward ends to pivot to an open configuration as shown in FIGS. 15 and 20.

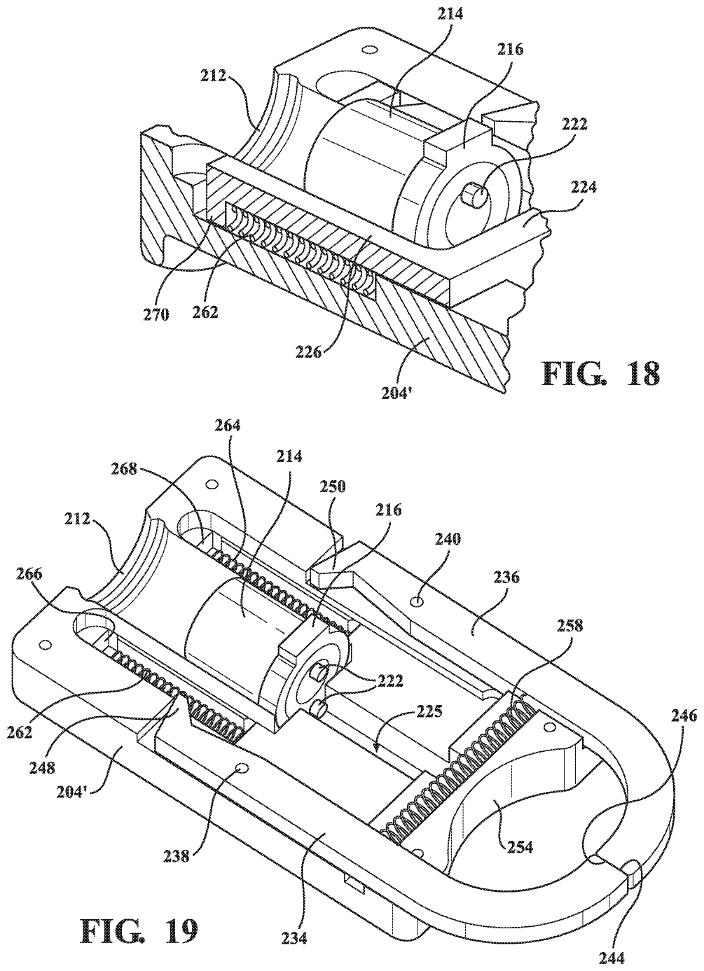

A pair of secondary springs (depicted at 262 and 264 in FIG. 19 with the “U” shaped slide component removed) are illustrated for biasing slide portions 226/228 of the “U” component, along with the displaceable portion 214 in a direction toward the housing inlet 212 to normally influence the clasps 234/236 into the locked or closed clasp position. As shown in the cutaway portion of FIG. 18, the secondary springs 262/264 extend within axial pockets 266 and 268 configured within the recesses of the lower assemble-able half 204′.

As further depicted in FIG. 18, the slide portions 226/228 each include an angled end tab (see selected tab 270 shown for slide 226) which bias the slide portions of the “U” shaped component, along with the displaceable portion 214 in a direction toward the inlet 212 of the housing defined body and thereby, absent the counter-influencing force exerted by the key portion 202, to maintain the slide notches 230/232 out of alignment with the clasp inner pointed portions 248/250.

Accordingly, the present invention provides for quick single handed bypass/switch engagement of the insert key portion into the outer receiving body by the user, again irrespective of the rotational position of the insert portion of the key relative to the fixed outer receiving portion and owing to the keyed configuration of the circumferential seating ring arrays of each of the insert and receiving portions for causing the ring arrays to nest together in order for the elongated pins (see again at 222 in FIG. 17) extending through the inner component.

Having described my invention, other and additional embodiments will become apparent to those skilled in the art to which it pertains and without deviating from the scope of the appended claims. This can include redesigning the inner or outer key portions to include varying cross sectional profiles, no limited to cylindrical, and which can include other polygonal or multi-sided profiles. Other variants can include the outer key portion being varied in its cross sectional profile, and so that it can be configured to match a given (non-circular) profile associated with the door jamb location.

I claim:

1. A two piece key assembly for maintaining a door associated with an enclosure in an open position, comprising:
a body adapted to being inserted through an opening in a frame of the enclosure associated with the door to prevent closing of the door, said body including at least one laterally projecting portion which, upon said outer portion being installed, preventing axial withdrawal from the frame location;
a key portion which, upon insertion within an opening in said body, engaging a displaceable portion supported within said body, which in turn causes said laterally projecting portion to retract into an interior of said body to permit linear withdrawing removal of said body and inserting key portion together from the frame location.

2. The assembly as described in claim 1, said outer body further comprising at least one linearly displacing slide, a notched lateral exterior location of said slide aligning with said projecting portion to facilitate retraction thereof.

3. The assembly as described in claim 1, said displaceable portion further comprising elongated pins extending through an intermediate component supported within said body in contact with said slides.

4. The assembly of claim 3, said at least one laterally projecting portion further comprising a pair of spherical elements.

5. The assembly of claim 4, said at least one slide further comprising a pair of slides supporting said spherical elements on opposite side locations in respective communication to said elongated pins so that said elements partially project through side apertures in said outer portion.

6. The assembly as described in claim 5, further comprising said pair of slides being slidably positioned side-by-side within said outer portion.

7. The assembly as described in claim 5, further comprising said slides being position in a stacked arrangement within said body, allowing for each slide to engage both of said spherical elements.

8. The assembly as described in claim 5, further comprising axial projecting rings configured in opposing ends of each of said inner key portion and said intermediate component which, upon mating, displacing said elongated pins seated within said intermediate component to align said notches for retracting said spherical elements.

9. The assembly as described in claim 8, said axial projecting rings of said inner key portion each further comprising a keyed length pattern which is sized to determine a degree of axial displacement of said pins and slides within said body.

10. The assembly as described in claim 9, further comprising a pair of annular recessed valleys configured into a forward facing end of said intermediate component and communicating with additional seating recesses configured within a rearward facing end through which are received said elongated pins projecting from said slides.

11. The assembly as described in claim 10, further comprising springs biasing said slides in a direction towards said open end of said body.

12. The assembly as described in claim 11, further comprising an interior wall supporting said slides at an intermediate location of said body separating said open end and a closed distal end.

13. The assembly as described in claim 12, further comprising axial displacement of said axial projecting rings causing said elongated pins to displace forwardly from said fixed intermediate component to displace said slides to retract and removal positions within said body.

14. A two piece key assembly, comprising:
a key inserting portion;
a body within which is formed an inlet for receiving said inserting portion, a displaceable portion positioned within an interior of said body in communication with said inlet;
a pair of clasps pivotally supported to said body and having opposing and contacting forward ends in a normally closed position; and
upon being engaged by said inserting portion, said forward ends of said clasps being caused by said displaceable portion to outwardly pivot to an open position.

15. The assembly as described in claim 14, further comprising slides disposed within said body, said clasps further having inward projections which, upon said slides being displaced by said displaceable portion into alignment with said projections, seating within opposing outward notches configured within said slides, a compressed spring extending between said clasps in said housing and biasing said inward projections against said slides such that, upon alignment of said slide notches with said projections, said compressed spring outwardly displacing said clasps at said forward ends to pivot open.

16. The assembly as described in claim 15, said displaceable portion further comprising elongated pins extending through an intermediate component seated within said body and communicating insertion of said key inserting portion to said slides.

17. The assembly as described in claim 16, further comprising a pair of secondary springs for biasing said slides toward said housing inlet to normally influence said clasps into a locked position.

18. The assembly as described in claim 16, further comprising opposing concentric ring arrays configured upon each of said key inserting portion and said displaceable portion which, upon nesting engagement, displacing said slides to align said notches with said inward projections.

19. The assembly of claim 17, further comprising tabs associated with the slides which are biased by said secondary springs embedded toward said housing inlet.

20. The assembly of claim 16, further comprising said slides being integrated into first and second spaced apart and extending sides of a “U” shaped component, said intermediate portion contacting a connecting base of said “U” shaped component with said pins extending through said intermediate component to displace said slides and notches into alignment with said clasp inward projections.
